(19) United States
(12) Patent Application Publication
(10) Pub. No.: US 2026/0063527 A1
(43) Pub. Date: Mar. 5, 2026

(54) METHODS AND APPARATUS FOR DILATIONAL INTERFACIAL RHEOLOGY

(71) Applicant: The University of British Columbia, Vancouver (CA)

(72) Inventors: John M. FROSTAD, Vancouver (CA); Yun-Han HUANG, Burnaby (CA)

(21) Appl. No.: 19/381,661

(22) Filed: Nov. 6, 2025

Related U.S. Application Data
(63) Continuation of application No. PCT/CA2024/050637, filed on May 10, 2024.
(60) Provisional application No. 63/465,340, filed on May 10, 2023.

(51) Int. Cl. G01N 11/00

(52) U.S. Cl. CPC G01N 11/00

(57) ABSTRACT

The invention provides an interfacial dilational strain apparatus. The interfacial dilational strain apparatus may comprise a body having a first surface facing in a first radial direction wherein the first surface defines a channel having an opening facing in the first radial direction. The interfacial dilational strain apparatus may comprise a deformable wall sealingly attached to the body to cover the opening of the channel wherein the deformable wall and the channel define a cavity. The interfacial dilational strain apparatus may comprise one or more ports fluidly connected to the cavity. The deformable wall may be deformable in the first radial direction by increasing a fluid pressure or volume within the cavity. The deformable wall may be deformable in a second radial direction opposite the first radial direction by decreasing the fluid pressure or volume within the cavity.

### CROSS-REFERENCE TO RELATED APPLICATIONS

This application is a continuation application of Patent Cooperation Treaty (PCT) application No. PCT/CA2024/050637 having an international filing date of 10 May 2024, which in turn claims priority from, and for the purposes of the United States the benefit under 35 USC 119 in relation to, U.S. patent application No. 63/465,340 filed on 10 May 2023, all of which are hereby incorporated herein by reference.

### TECHNICAL FIELD

The present invention relates to the field of interfacial rheology and in particular to methods and apparatus for dilational interfacial rheology.

### BACKGROUND OF THE INVENTION

Interfacial rheology, the stress-strain relationship of interfaces, plays a significant role in several fields. For example, research has shown that the rheology of interfaces can impact the drainage time of films, which can affect the formation and stability of foam and emulsion systems. Additionally, the interfacial rheology at the surface of alveoli is directly related to respiratory function in the human body and is influenced by various lung surfactants.

Despite the significance of interfacial rheology in various applications, our understanding of it remains limited. This is due in part to a lack of effective measurement techniques. When characterizing interfacial rheology, it is desirable to limit the type or types of strain (such as pure shear or pure dilation) applied to an interface to reduce the need to decouple the contribution from each type of strain and to simplify the data analysis process. Several robust commercial instruments have been developed for the measurement of interfacial shear deformations. However, existing rheometers for the dilation of interfaces suffer from limitations.

There is a general desire for methods and apparatus for characterization of dilational rheology of interfaces to aid in validation of theoretical models and to further enable the use of dilational rheology as a formulation tool for commercial products.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an interfacial dilational strain apparatus. The apparatus may comprise a body having a first surface facing in a first radial direction wherein the first surface defines a channel having an opening facing in the first radial direction. The apparatus may comprise a deformable wall sealingly attached to the body to cover the opening of the channel wherein the deformable wall and the channel define a cavity. The apparatus may comprise one or more ports fluidly connected to the cavity. The deformable wall may be deformable in the first radial direction by increasing a fluid pressure or volume within the cavity. The deformable wall may be deformable in a second radial direction opposite the first radial direction by decreasing the fluid pressure or volume within the cavity.

In some embodiments, a first surface of the deformable wall defines a spine, the spine protruding in the first radial direction from the first surface of the deformable wall. In some embodiments, the spine extends around an entirety of the first surface of the deformable wall. In some embodiments, the spine extends around at least a portion of the first surface of the deformable wall. In some embodiments, a tip of the spine is aligned with an axial direction midpoint of the channel. In some embodiments, at least a portion of the spine is substantially triangular in cross-section. In some embodiments, an axial direction dimension of the spine tapers in the first radial direction. In some embodiments, at least a portion of the spine is substantially rectangular in cross-section.

In some embodiments, the deformable wall is sealingly attached to the first surface of the body. In some embodiments, the deformable wall is sealingly attached to the first surface of the body by adhesive. In some embodiments, the deformable wall is sealingly attached to the body by clamping at least a portion of the deformable wall to the body.

In some embodiments, the apparatus comprises a first clamp removably attachable to the body and a second clamp removably attachable to the body wherein at least a first portion of the deformable wall is clamped between the first clamp and the body and at least a second portion of the deformable wall is clamped between the second clamp and the body to thereby sealingly attach the deformable wall to the body. In some embodiments, the first clamp is annular and the second clamp is annular. In some embodiments, the first and second clamps are each attached to the body by one or more fasteners. In some embodiments, the one or more fasteners comprise screws. In some embodiments, the one or more fasteners comprise rivets. In some embodiments, the first and second clamps are each attached to the body by adhesive.

In some embodiments, the channel is substantially rectangular in cross-section. In some embodiments, the channel is substantially round in cross-section. In some embodiments, the channel is substantially semi-circular in cross-section.

In some embodiments, the body comprises metal. In some embodiments, the body comprises a composite material. In some embodiments, the body comprises a polymer. In some embodiments, the body comprises Delrin™. In some embodiments, the body comprises polycarbonate. In some embodiments, the body comprises glass.

In some embodiments, the deformable wall comprises a polymer. In some embodiments, the deformable wall comprises an elastomeric material. In some embodiments, the deformable wall comprises polydimethylsiloxane, fluoroelastomer, fluorosilicone or mixtures thereof. In some embodiments, the deformable wall comprises a polydimethylsiloxane.

In some embodiments, the one or more ports open in the second radial direction away from the annular body. In some embodiments, the one or more ports open axially away from the annular body.

In some embodiments, the apparatus comprises a pressure controller fluidly connected to the one or more ports and operable to control the fluid pressure or volume within the cavity by forcing fluid into or out of the cavity. In some embodiments, the fluid is a gas. In some embodiments, the fluid is a liquid. In some embodiments, the pressure controller is operable to oscillate the fluid pressure or volume within the cavity at a frequency of between approximately 0.0001 Hz and 10 Hz.

In some embodiments, the apparatus comprises a displacement sensor within the cavity for determining a displacement of at least a portion of the deformable wall.

In some embodiments, the first radial direction is a radially-inward direction and the second radial direction is a radially-outward direction. In some embodiments, the body is an annular body. In some embodiments, the deformable wall is deformable radially inwardly to decrease an inner diameter of a space defined by the deformable wall by between approximately 0.01% to approximately 10% by increasing the fluid pressure or volume within the cavity and the deformable wall is deformable radially outwardly to increase the inner diameter of the space defined by the deformable wall by between approximately 0.01% to approximately 10% by decreasing the fluid pressure or volume within the cavity.

In some embodiments, the first radial direction is a radially-outward direction and the second radial direction is a radially-inward direction. In some embodiments, the body is a cylindrical body. In some embodiments, the deformable wall is deformable radially outwardly to increase a diameter of the deformable wall by between approximately 0.01% to approximately 10% by increasing the fluid pressure or volume within the cavity and the deformable wall is deformable radially inwardly to decrease diameter of the deformable wall by between approximately 0.01% to approximately 10% by decreasing the fluid pressure or volume within the cavity.

In some embodiments, the apparatus comprises an annular secondary body wherein the annular secondary body defines a space and the body is located at least partially within the space. In some embodiments, the body and the secondary body are arranged concentrically. In some embodiments, the apparatus comprise one or more connectors attaching the secondary body to the body. In some embodiments, the one or more connectors are located on a first axial side of the body and a first axial side of the secondary body. In some embodiments, the one or more connectors are located below the body and below the secondary body. In some embodiments, the body and secondary body are integrally formed. In some embodiments, the body and secondary body are attached by one or more fasteners. In some embodiments, the body and secondary body are attached by adhesive.

Another aspect of the invention provides another interfacial dilational strain apparatus. The interfacial dilational strain apparatus comprises an annular body having a first surface facing in a radial inward direction wherein the first surface defines a channel having an opening facing in the radial inward direction. The interfacial dilational strain apparatus comprises a deformable wall sealingly attached to the body to cover the opening of the channel wherein the deformable wall and the channel define a cavity. The interfacial dilational strain apparatus comprises one or more ports fluidly connected to the cavity. The deformable wall may be deformable in the radial inward direction by increasing a fluid pressure or volume within the cavity. The deformable wall may be deformable in a radial outward direction by decreasing the fluid pressure or volume within the cavity.

Another aspect of the invention provides another interfacial dilational strain apparatus. The interfacial dilational strain apparatus comprises a cylindrical body having a first surface facing in a radial outward direction wherein the first surface defines a channel having an opening facing in the radial outward direction. The interfacial dilational strain apparatus comprises a deformable wall sealingly attached to the body to cover the opening of the channel wherein the deformable wall and the channel define a cavity. The interfacial dilational strain apparatus comprises one or more ports fluidly connected to the cavity. The deformable wall may be deformable in the radial outward direction by increasing a fluid pressure or volume within the cavity. The deformable wall may be deformable in a radial inward direction by decreasing the fluid pressure or volume within the cavity.

Another aspect of the invention provides another interfacial dilational strain apparatus. The interfacial dilational strain apparatus comprises an annular body having a first surface facing in a radial inward direction wherein the first surface defines a first channel having a first opening facing in the radial inward direction. The interfacial dilational strain apparatus comprises a cylindrical body having a second surface facing in a radial outward direction wherein the second surface defines a second channel having a second opening facing in the radial outward direction. The interfacial dilational strain apparatus comprises a first deformable wall sealingly attached to the annular body to cover the first opening of the first channel wherein the first deformable wall and the first channel define a first cavity. The interfacial dilational strain apparatus comprises a second deformable wall sealingly attached to the cylindrical body to cover the second opening of the second channel wherein the second deformable wall and the second channel define a second cavity. The interfacial dilational strain apparatus comprises one or more first ports fluidly connected to the first cavity. The interfacial dilational strain apparatus comprises one or more second ports fluidly connected to the second cavity. The first deformable wall may be deformable in the radial inward direction by increasing a fluid pressure or volume within the first cavity. The first deformable wall may be deformable in the radial outward direction by decreasing the fluid pressure or volume within the first cavity. The second deformable wall may be deformable in the radial outward direction by increasing a fluid pressure or volume within the second cavity. The second deformable wall may be deformable in the radial inward direction by decreasing the fluid pressure or volume within the second cavity.

Another aspect of the invention provides an interfacial dilation rheometer comprising. The rheometer comprises an open container. The rheometer comprises an interfacial dilational strain apparatus of as described herein wherein the interfacial dilational strain apparatus is located at least partially within the open container. The rheometer comprises a stress sensor configured to determine a stress at an interface of a fluid receivable within the open container.

In some embodiments, the open container comprises a Langmuir trough.

In some embodiments, the rheometer comprises one or moveable barriers for applying a strain to the interface of the fluid receivable within the open container.

In some embodiments, the stress sensor comprises a force sensor. In some embodiments, the stress sensor comprises a probe and a balance. In some embodiments, the probe comprises a Wilhelmy rod. In some embodiments, the probe comprises a ring probe. In some embodiments, the balance comprises a microbalance.

In some embodiments, the rheometer comprises a stand to support the probe. In some embodiments, the stand is actuatable to raise and lower the probe.

In some embodiments, the rheometer comprises a pressure controller for controlling the fluid pressure or volume within the cavity of the interfacial dilational strain apparatus.

In some embodiments, the rheometer comprises an anti-vibration platform for isolating the open container from undesirable vibrations.

In some embodiments, the rheometer comprises a heat system for heating the fluid receivable within the open container.

In some embodiments, the rheometer comprises a camera for monitoring a displacement of the deformable wall of the interfacial dilational strain apparatus.

In some embodiments, the rheometer comprises a stand to support the interfacial dilational strain apparatus. In some embodiments, the stand is actuatable to raise and lower the interfacial dilational strain apparatus.

In some embodiments, the rheometer comprises a fluid circulation system to circulate fluid in and out of the open container.

In some embodiments, the rheometer comprises an enclosure enclosing the open container, the interfacial dilational strain apparatus and at least a portion of the stress sensor.

In some embodiments, the rheometer comprises a humidity control system for controlling a humidity within the enclosure. In some embodiments, the rheometer comprises a temperature control system for controlling a temperature within the enclosure. In some embodiments, the rheometer comprises a pressure control system for controlling the fluid pressure or volume within the enclosure.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a schematic depiction of a cross-section of an interfacial dilational strain apparatus for controllably applying dilational strain to a fluid interface according to an example embodiment of the invention. FIG. 1B is a schematic top view of the interfacial dilational strain apparatus of FIG. 1A.

FIG. 2A is a schematic depiction of a cross-section of the interfacial dilational strain apparatus of FIG. 1A. FIG. 2B is another schematic depiction of a cross-section of the interfacial dilational strain apparatus of FIG. 1A. FIG. 2C is another schematic depiction of a cross-section of the interfacial dilational strain apparatus of FIG. 1A.

FIG. 3A is a schematic depiction of a cross-section of another interfacial dilational strain apparatus for controllably applying dilational strain to a fluid interface according to an example embodiment of the invention. FIG. 3B is a schematic top view of the interfacial dilational strain apparatus of FIG. 3A.

FIG. 4A is a schematic depiction of a cross-section of another interfacial dilational strain apparatus for controllably applying dilational strain to a fluid interface according to an example embodiment of the invention. FIG. 4B is a schematic top view of the interfacial dilational strain apparatus of FIG. 4A.

FIG. 5 is another schematic cross section of the interfacial dilational strain apparatus of FIG. 1A.

FIG. 6A is a schematic depiction of a cross-section of another interfacial dilational strain apparatus for controllably applying dilational strain to a fluid interface according to an example embodiment of the invention. FIG. 6B is a schematic top view of the interfacial dilational strain apparatus of FIG. 6A.

FIG. 7A is a schematic depiction of a cross-section of another interfacial dilational strain apparatus for controllably applying dilational strain to a fluid interface according to an example embodiment of the invention. FIG. 7B is a schematic top view of the interfacial dilational strain apparatus of FIG. 7A.

FIG. 8 is a schematic depiction of an interfacial dilational rheometer according to an example embodiment of the invention.

FIG. 9 is a plot of a compression isotherm of stearic acid.

FIG. 10A is a plot of dilational complex modulus and phase angle as a function of frequency for 2.85 mM Sodium dodecylbenzenesulfonate aqueous solution. FIG. 10B is a plot of dilational complex modulus and phase angle as a function of amplitude for 2.85 mM Sodium dodecylbenzenesulfonate aqueous solution.

FIG. 11A is a schematic depiction of a cross-section of another interfacial dilational strain apparatus for controllably applying dilational strain to a fluid interface according to an example embodiment of the invention. FIG. 11B is a schematic top view of the interfacial dilational strain apparatus of FIG. 11A.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides an interfacial dilational strain apparatus for controllably applying dilational strain to a fluid interface. The fluid interface may be, for example, a liquid-gas interface or a liquid-liquid interface. The interfacial dilational strain apparatus may comprise a body. The body may be annular. The body may be cylindrical. The body may have a first surface facing in a first radial direction (e.g., radially inwardly or radially outwardly). The first surface defines a channel having an opening which opens in the first radial direction. A deformable wall may be sealingly attached to the body to cover the opening of the channel. Together, the deformable wall and the channel define a cavity. One or more ports may be fluidly connected to the cavity. In some embodiments, the deformable wall is deformable in the first radial direction by increasing the fluid pressure or volume within the cavity. In some embodiments, the deformable wall is deformable in a second radial direction opposite the first radial direction by decreasing the fluid pressure or volume within the cavity.

In some embodiments, the interfacial dilational strain apparatus comprises an annular body having a radially inward-facing surface wherein the inward-facing surface defines a channel having a radially inward-facing opening. A deformable wall may be sealingly attached to the annular body to cover the radially inward-facing opening of the channel. Together, the deformable wall and the channel define a cavity. One or more ports may be fluidly connected to the cavity. In some embodiments, the deformable wall is deformable radially inwardly by increasing the fluid pressure or volume within the cavity. In some embodiments, the deformable wall is deformable radially outwardly by decreasing the fluid pressure or volume within the cavity.

In some embodiments, the interfacial dilational strain apparatus comprises a cylindrical body having a radially outward-facing surface wherein the outward-facing surface defines a channel having a radially outward-facing opening. A deformable wall may be sealingly attached to the annular body to cover the radially outward-facing opening of the channel. Together, the deformable wall and the channel define a cavity. One or more ports may be fluidly connected to the cavity. In some embodiments, the deformable wall is deformable radially outwardly by increasing the fluid pressure or volume within the cavity. In some embodiments, the deformable wall is deformable radially inwardly by decreasing the fluid pressure or volume within the cavity.

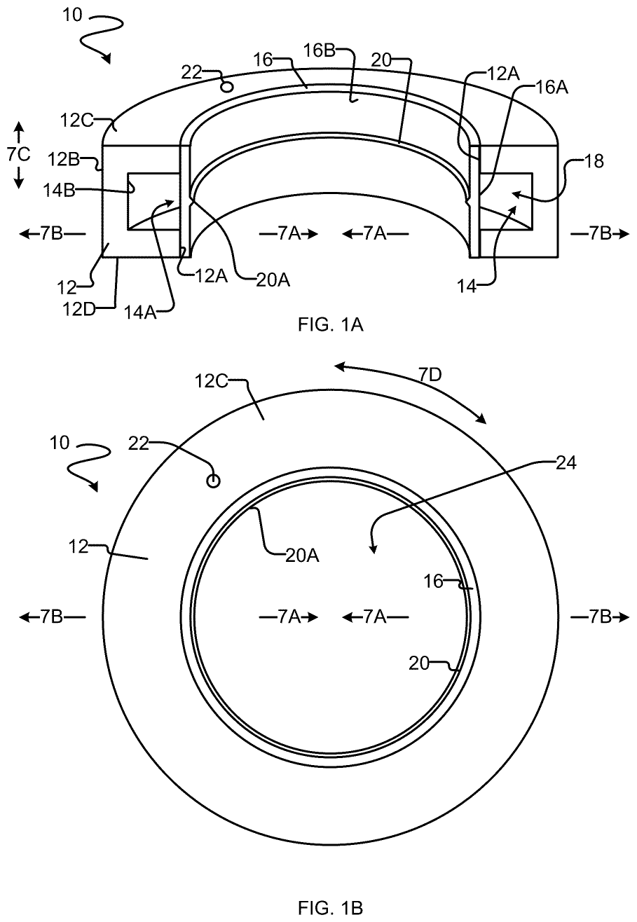

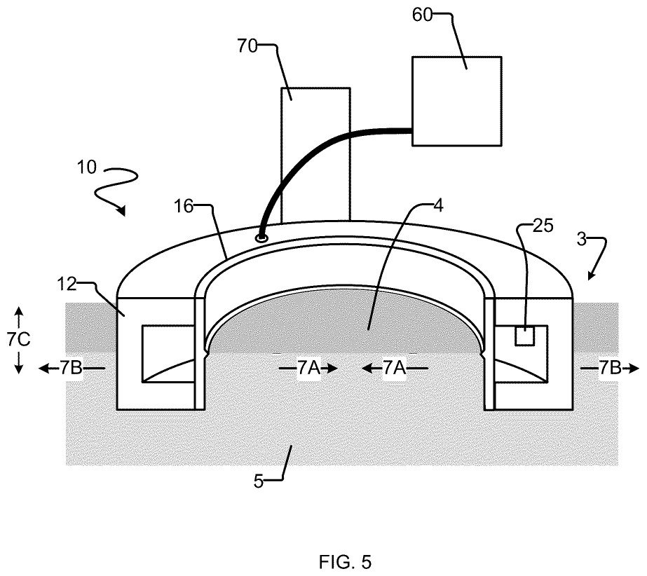

FIGS. 1A and 1B depict an interfacial dilational strain apparatus 10 (referred to herein simply as apparatus 10) according to an example embodiment of the invention. Apparatus 10 may be employed to controllably apply dilational strain to a fluid interface 4 between fluid 3 and fluid 5 as shown in FIG. 5. For ease of illustration, fluid 3 is depicted as a clear fluid in FIG. 5. Fluid interface 4 may be, for example, a liquid-gas interface (e.g., where fluid 5 comprises a liquid and fluid 3 comprises a gas) or a liquid-liquid interface (e.g., where both fluid 3 and fluid 5 comprise liquids). Fluid interface 4 may also comprise another material that is insoluble in either fluid phase, such as proteins, solid particles, etc.

Apparatus 10 may comprise a body 12. Body 12 may be substantially annular in shape as best seen in FIG. 1B. Body 12 may have a radially inwardly facing inner surface 12A (e.g., inner surface 12A faces in radial inward direction 7A) and a radially outwardly facing outer surface 12B (e.g., outer surface 12B faces in radial outward direction 7B). Body 12 may have opposing axial direction 7C facing surfaces 12C and 12D.

Inner surface 12A may define a channel 14, as best seen in FIG. 1A. Channel 14 may have a radially inwardly facing opening 14A (e.g., opening 14A opens in radial inward direction 7A). Channel 14 may have any suitable cross-sectional shape. For example, channel 14 may have a substantially rectangular cross-sectional shape as shown in FIG. 1A. This is not mandatory. Channel 14 may have a round (e.g., semi-circular) cross-sectional shape.

Body 12 may be fabricated out of any suitable material. For example, body 12 may comprise a metal (e.g., aluminum alloy, steel, brass, etc.), a polymer (e.g., polycarbonate, nylon, Delrin™, etc.), a glass, a composite (e.g., glass fiber reinforced polymer or carbon fiber reinforced polymer), etc. In some embodiments, a material of body 12 is chosen so as to be non-reactive with fluid 3 and/or fluid 5.

Apparatus 10 may comprise a deformable wall 16. Deformable wall 16 may be attached to body 12 to cover opening 14A of channel 14. Deformable wall 16 may be sealingly attached to body 12 to sealingly cover opening 14A.

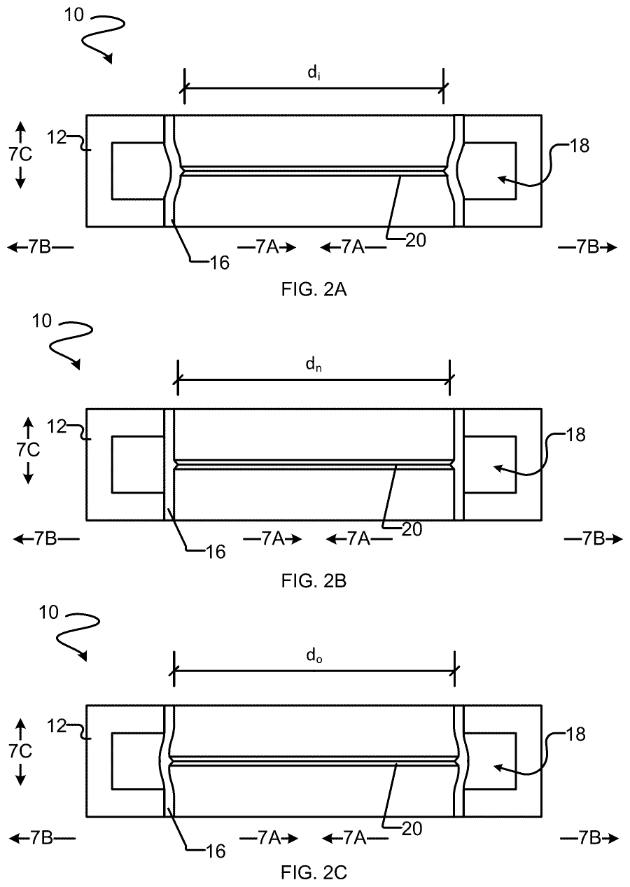

Together, an inner surface 14B of channel 14 and a radially outwardly facing surface 16A of deformable wall 16 define a cavity 18. Due to the seal between deformable wall 16 and channel 14, deformable wall 16 is deformable in response to increases or decreases in fluid (e.g., gas or liquid) within cavity 18 and/or pressure changes within cavity 18. For example, an increase in fluid volume and/or fluid pressure within cavity 18 may cause deformable wall 16 to deform radially inwardly (e.g., in direction 7A) as shown, for example, in FIG. 2A. Likewise, a decrease in fluid volume and/or fluid pressure within cavity 18 may cause deformable wall to deform radially outwardly (e.g., in direction 7B) as shown, for example, in FIG. 2C.

Deformable wall 16 may be attached to body 12 in any suitable manner. For example, deformable wall 16 may be adhered or bonded to body 12, clamped to body 12, fastened to body 12, etc. In some embodiments, deformable wall 16 is attached to at least a portion of inner surface 12A of body 12. In some embodiments, deformable wall 16 is additionally or alternatively attached to at least a portion of one or both of first and second axial direction 7C facing surfaces 12C, 12D of body 12.

Deformable wall 16 may comprise any material suitable for deformation in response to changes in fluid volume and/or pressure within cavity 18. Deformable wall 16 may comprise any material suitable for elastic deformation in response to changes in fluid volume and/or pressure within cavity 18. Deformable wall 16 may comprise an elastomeric material. Deformable wall 16 may comprise a polymer or a rubber. Deformable wall 16 may comprise, for example, polydimethylsiloxane, fluoroelastomer, fluorosilicone or mixtures thereof. In some embodiments, deformable wall 16 comprises polydimethylsiloxane.

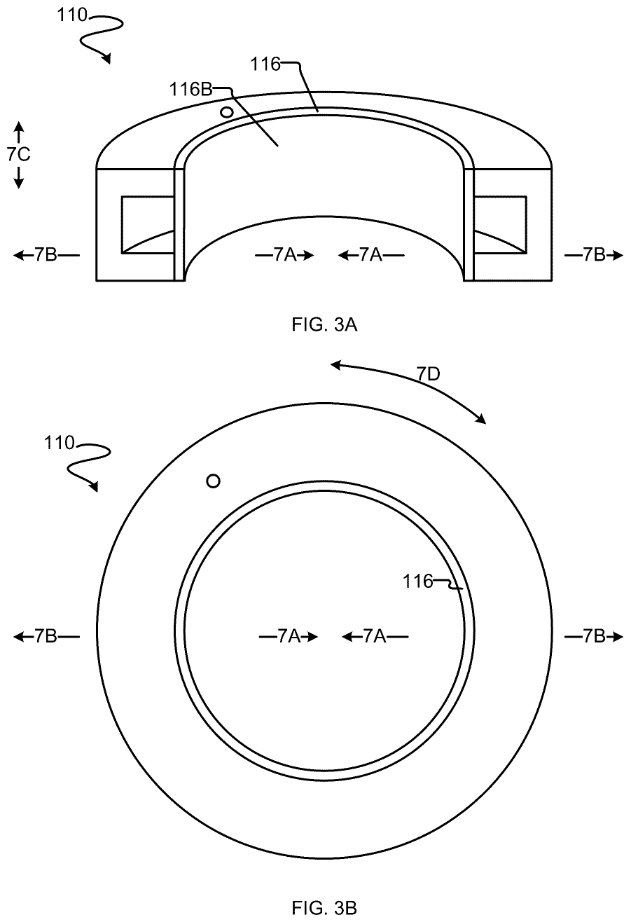

In some embodiments, a radially inwardly facing surface 16B of deformable wall 16 defines a spine 20. This is not mandatory. For example, FIGS. 3A and 3B depict an interfacial dilational strain apparatus 110 (referred to herein simply as apparatus 110) according to an example embodiment of the invention. Apparatus 110 is substantially similar to apparatus 10 except that a radially inwardly facing surface 116B of deformable wall 116 does not define a spine.

Spine 20 may protrude radially inwardly from surface 16B. In some embodiments, spine 20 extends in circumferential direction 7D around an entirety of surface 16B, as shown in FIG. 1B. This is not mandatory. In some embodiments, spine 20 extends in circumferential direction 7D around only a portion of surface 16B. In some embodiments, spine 20 comprises a plurality of segments spaced apart in circumferential direction 7D around surface 16B. An innermost portion of spine 20 (e.g., a tip 20A of spine 20) may define an opening 24. Opening 24 may be round (e.g., circular).

Spine 20 may have any suitable cross-sectional shape. In some embodiments, spine 20 is symmetric about a radially extending plane that intersects an axial midpoint of spine 20. In some embodiments, spine 20 is symmetric about a radially extending plane that intersects an axial midpoint of deformable wall 16. In some embodiments, spine 20 is symmetric about a radially extending plane that intersects an axial midpoint of cavity 18. In some embodiments, spine 20 has a cross-sectional shape that is substantially polygonal (e.g., triangular, rectangular, etc.). In the FIG. 1A embodiment, spine 20 has a substantially triangular cross-sectional shape. In some embodiments, spine 20 defines a radially inwardly pointing tip 20A. In some embodiments, spine 20 defines multiple radially inwardly pointing tips. In some embodiments, spine 20 has a cross-sectional shape that is at least partially round (e.g., semi-circular).

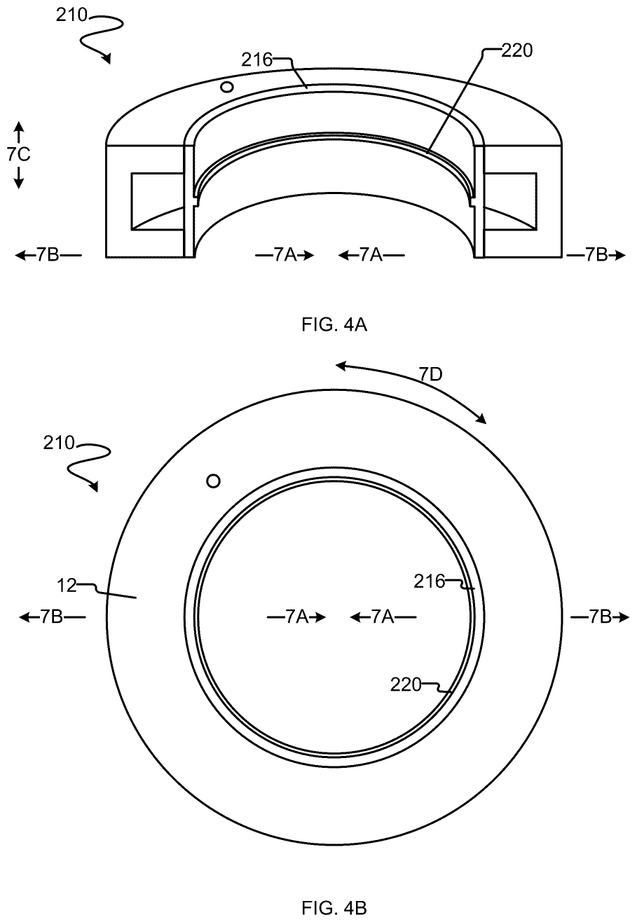

FIGS. 4A and 4B depict an interfacial dilational strain apparatus 210 (referred to herein simply as apparatus 210) according to an example embodiment of the invention. Apparatus 210 is substantially similar to apparatus 10 except that a spine 220 of deformable wall 216 is rectangular in cross-section.

In some embodiments, an axial direction 7C midpoint of spine 20 is aligned with an axial direction 7C midpoint of channel 16. Alignment of the axial direction 7C midpoint of spine 20 with the axial direction 7C midpoint of channel 16 may cause spine 20 to effectively translate in radial inward direction 7A and radial outward direction 7B when deformable wall 16 deforms without (or with a limited amount of) undesirable axial direction 7C movement of spine 20 and/or rotation of spine 20.

In practice, spine 20 (e.g., tip 20A of spine 20) may be aligned with interface 4 between fluid 3 and fluid 5 as shown, for example, in FIG. 5. Aligning spine 20 (e.g., tip 20A of spine 20) with interface 4 may pin interface 4 to spine 20 and thereby prevent or mitigate the formation of an undesirable meniscus where fluid 3 and/or fluid 5 contacts surface 16B of deformable wall 16. Alternatively, where spine 20 comprises multiple tips, interface 4 may be aligned between the tips to thereby pin interface 4 to spine 20 and thereby prevent or mitigate the formation of an undesirable meniscus where fluid 3 and/or fluid 5 contacts surface 16B of deformable wall 16.

Body 12 and opening 24 may have any suitable diameter. For example, in some embodiments, opening 24 is between approximately 10 mm and 60 mm in diameter. In some embodiments, a diameter of opening 24 is chosen to minimize the effect of the meniscus where interface 4 contacts a probe (e.g., probe 530A, discussed further herein) used to measure one or more characteristics of interface 4. Ideally, the diameter of opening 24 should be much larger than the length scale of the meniscus at the probe in order to treat the interface as effectively flat in the theoretical analysis. To quantify this, one can consider the ratio between the capillary length and the radius of the interface 7, according to Equation 1:

$$\frac{{l}_{capillary}^{2}}{{R}^{2}} = \frac{σ}{Δρ {gR}^{2}} = \frac{1}{Bo} . \qquad ( Equation 1 )$$

where σ is the surface tension, Δρ is the density difference between fluid 3 and fluid 5, g is gravity, and R is the radius of opening 24. While it may be desirable that Bo>>1, physical constraints such as the size of a typical Langmuir trough, put a limit on this. The radius of opening 24 also influences the maximum and minimum strain that can be achieved as well as the relative importance of gravitational flows.

One or more ports 22 may be provided to allow fluid (e.g., liquid and/or gas) to travel into and out of cavity 18. Each port 22 may define an aperture in body 12 to allow fluid to travel into and out of cavity 18.

A sensor 25 may optionally be provided to measure (directly or indirectly) a displacement of one or more portions of deformable wall 16 as it deforms radially inwardly and outwardly. In some embodiments, sensor 25 is located within cavity 18 (as shown in FIG. 5). In some embodiments, sensor 25 is located outside cavity 18. In some embodiments, sensor 25 comprises a displacement sensor. Sensor 25 may be any suitable type of displacement sensor such as a capacitive displacement sensor, a displacement transducer, a linear variable differential transformer, a potentiometer, an ultrasound displacement sensor, an encoder, an electromagnetic induction displacement sensor, a laser displacement sensor, a transducer, an optical sensor (e.g., a camera), etc. In some embodiments, sensor 25 comprises a pressure sensor and displacement of deformable wall 16 is determined based on pressure.

A pressure controller 60 may optionally be connected to port(s) 22 to control the flow of fluid into and out of cavity 18. Pressure controller 60 may comprise any suitable pressure controller 60. Pressure controller 60 may be operable to increase and decrease the volume of fluid and/or pressure within cavity 18 by causing fluid to flow into and out of cavity 18 through port(s) 22 thereby causing deformable wall 16 to deform radially inwardly or outwardly.

In some embodiments, pressure controller 60 is operable to cause deformable wall 16 to oscillate between a radially inwardly deformed position (e.g., as shown in FIG. 2A) and a radially outwardly deformed position (e.g., as shown in FIG. 2C). In some embodiments, pressure controller 60 is operable to cause deformable wall 16 to oscillate between a radially inwardly deformed position (e.g., as shown in FIG. 2A) and a neutral position (e.g., as shown in FIG. 2B). In some embodiments, pressure controller 60 is operable to cause deformable wall 16 to oscillate between a neutral position (e.g., as shown in FIG. 2B) and a radially outwardly deformed position (e.g., as shown in FIG. 2C). In some embodiments, pressure controller 60 is operable to cause deformable wall 16 to oscillate with a frequency of between approximately 0.0001 Hz and 10 Hz.

Opening 24 may have a diameter, dₙ, when deformable wall 16 is in the neutral state (e.g., where pressure within cavity 18 is equal to the pressure exerted on deformable wall 16 by fluid 3 and fluid 5), a diameter, dᵢ, when deformable wall 16 is in the radially inwardly deformed position (e.g., as shown in FIG. 2A) and a diameter, dₒ, when deformable wall 16 is in the radially outwardly deformed position (e.g., as shown in FIG. 2C).

In some embodiments, a percentage change between diameter, dₙ, and diameter, dₒ, is between approximately 0.0001% and 10%. In some embodiments, a percentage change between diameter, dₙ, and diameter, dᵢ, is between approximately 0.0001% and 10%. In some embodiments, a percentage change between diameter, dₒ, and diameter, dᵢ, is between approximately 0.0001% and 10%.

The pressure in cavity 18 may be modulated using a standard feedback controller to achieve the desired deformations of deformable wall 16. By defining the area strain of opening 24 such that an increase in area of opening 24 is a positive area strain, and a positive deformation of deformable wall 16 corresponds to increase in area of opening 24, Equation 2 may be obtained as follows:

$$ϵ = \frac{{R}^{2} - {R}_{0}^{2}}{{R}_{0}^{2}} ; R = {R}_{0} + δ \to \frac{δ}{{R}_{0}} = \sqrt{ϵ + 1} - 1 \qquad ( Equation 2 )$$

where ε is the area strain of opening 24 (which is also the strain of interface 7), R is the radius of opening 24, and δ is the change of the radius of opening 24 or the maximum displacement of deformable wall 16. By assuming linear elasticity of deformable wall 16, the relationship between pressure in cavity 18, P*, and deformation of deformable wall 16 can be written as Equation 3:

$${P}^{*} = 2 \overline{t} {δ}^{*} [ \frac{1}{2 {δ}^{*}} {sin}^{- 1} 2 {δ}^{*} - 1 ] + [ \frac{1}{2} \frac{\overline{t}}{{\overline{R}}_{0} + {δ}^{*}} + \frac{\overline{b} {δ}^{*}}{( {\overline{R}}_{0} + {δ}^{*} ) {sin}^{- 1} 2 {δ}^{*}} ] \frac{{δ}^{*}}{{\overline{R}}_{0}} \qquad ( Equation 3 )$$

Equation 2 can be further reduced by substituting sin⁻¹ 2δ⁻ with the first two terms of its Taylor expansion (sin⁻¹ 2δ⁻+(4/3)δ⁻³) and making the approximation δ⁻<<R based on the designed configuration of apparatus 10 to obtain Equation 3 which may be employed to control pressure controller 60:

$${P}^{*} = \frac{4}{3} \overline{t} {δ}^{* 3} + \frac{\overline{t} + \overline{b}}{2 {\overline{R}}_{0}^{2}} {δ}^{*} \qquad ( Equation 4 )$$

In some embodiments, an arm 70 is attachable to body 12 to controllably raise and lower apparatus 10. Arm 70 may be manually operable or may be actuated electronically, pneumatically, hydraulically, etc.

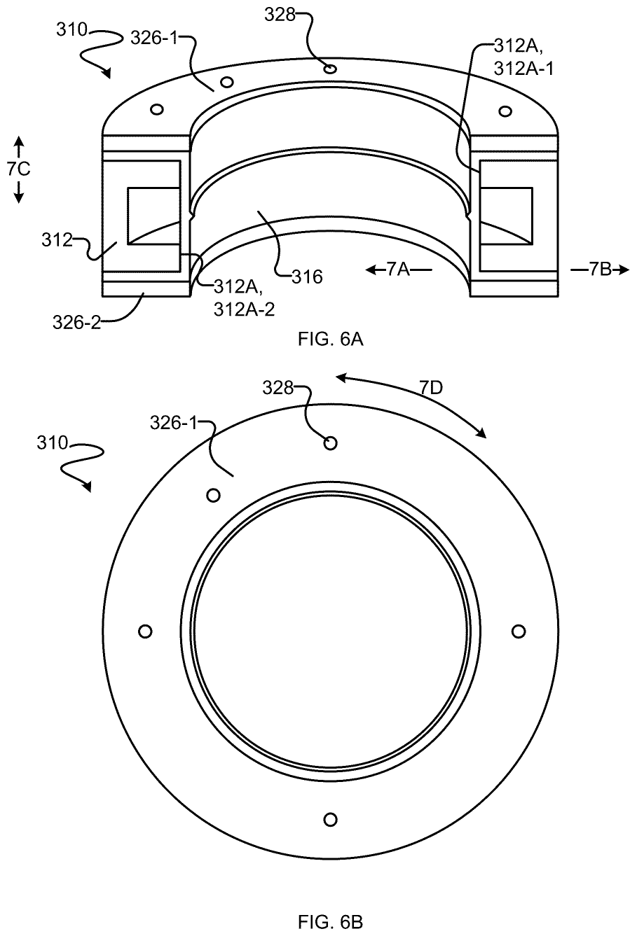

FIGS. 6A and 6B depict an interfacial dilational strain apparatus 310 (referred to herein simply as apparatus 310) according to an example embodiment of the invention. Apparatus 310 is substantially similar to apparatus 10 except as follows. As such, like components of apparatus 310 have been illustrated with reference numerals incremented by 300 (as compared to components of apparatus 10).

Apparatus 310 comprises a first clamp 326-1 to clamp at least a portion of deformable wall 316 between body 312 and first clamp 326-1 and a second clamp 326-2 to clamp at least a portion of deformable wall 316 between body 312 and second clamp 326-1. First and second clamps thereby sealably attach deformable wall 316 to body 312 of apparatus 310.

First clamp 326-1 and second clamp 326-2 may each be annular in shape, as shown in FIG. 6A such that first clamp 326-1 clamps at least a portion of deformable wall 316 against axial direction 7C facing surface 312C of body 312 and a second clamp 326-2 clamps at least a portion of deformable wall 316 against axial direction 7C facing surface 312D of body 312.

Alternatively or additionally, first clamp 326-1 may clamp at least a portion of deformable wall 316 against an upper portion 312A-1 of radially inwardly facing surface 312A of body 312 and second clamp 326-2 may clamp at least a portion of deformable wall 316 against a lower portion 312A-2 of radially inwardly facing surface 312A of body 312.

While first clamp 326-1 and second clamp 326-2 are each depicted as being single pieces of material, it should be understood that each of first clamp 326-1 and second clamp 326-2 may comprise multiple separate segments which work together to clamp deformable wall 316 to body 312.

First clamp 326-1 and second clamp 326-2 may be attached to body 312 by one or more fasteners 328. Fasteners 328 may comprise any suitable type of fasteners such as screws, rivets or the like. As deformable wall 316 may be detached from body 312 by releasing fasteners 328, deformable wall 316 may be easily replaceable.

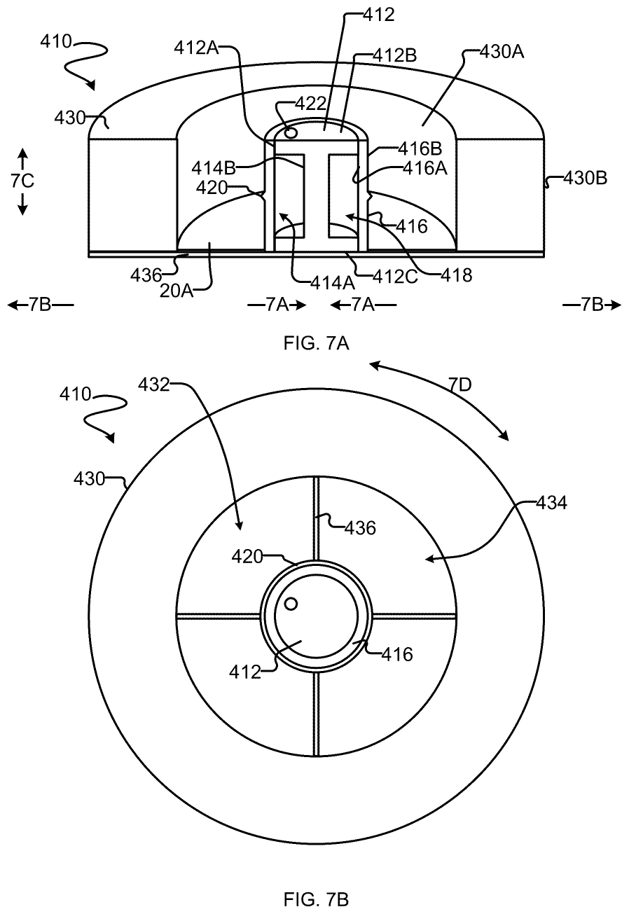

FIGS. 7A and 7B depict an interfacial dilational strain apparatus 410 (referred to herein simply as apparatus 410) according to an example embodiment of the invention. Apparatus 410 may be substantially similar to apparatus 10, except as described herein. As such, like components of apparatus 410 have been illustrated with reference numerals incremented by 400 (as compared to components of apparatus 10).

Apparatus 410 may comprise a body 412. Body 412 may be substantially similar to body 12, except as described herein. Body 412 may be substantially cylindrical in shape as best seen in FIG. 7B. Body 412 may have a radially outwardly facing outer surface 412A (e.g., outer surface 412A faces in radial outward direction 7B). Body 412 may have opposing axial direction 7C facing surfaces 412B and 412C.

Outer surface 412A may define a channel 14, as best seen in FIG. 7A. Channel 414 may have a radially outwardly facing opening 414A (e.g., opening 414A opens in radial outward direction 7B). Channel 414 may have any suitable cross-sectional shape. For example, channel 414 may have a substantially rectangular cross-sectional shape as shown in FIG. 7A. This is not mandatory. Channel 414 may have a round (e.g., semi-circular) cross-sectional shape.

Apparatus 410 may comprise a deformable wall 416. Deformable wall 416 may be substantially similar to deformable wall 16, except as described herein. Deformable wall 416 may be attached to body 412 to cover opening 414A of channel 414. Deformable wall 416 may be sealingly attached to body 412 to sealingly cover opening 414A. Deformable wall 416 may be attached to body 412 in any suitable manner. For example, deformable wall 416 may be adhered or bonded to body 412, clamped to body 412 (e.g., in a similar manner to how deformable wall 316 is bonded to body 312), fastened to body 412, etc.

Together, an inner surface 414B of channel 414 and a radially inwardly facing surface 416A of deformable wall 416 define a cavity 418. Due to the seal between deformable wall 416 and channel 414, deformable wall 416 is deformable in response to increases or decreases in fluid (e.g., gas or liquid) within cavity 418 and/or pressure changes within cavity 418. For example, an increase in fluid volume and/or fluid pressure within cavity 418 may cause deformable wall 416 to deform radially outwardly. Likewise, a decrease in fluid volume and/or fluid pressure within cavity 418 may cause deformable wall to deform radially inwardly.

In some embodiments, a radially outwardly facing surface 416B of deformable wall 416 defines a spine 420. This is not mandatory. Spine 420 may be substantially similar to spine 20 except in that spine 420 protrudes radially outwardly from radially outwardly facing surface 416B (as compared to spine 20 which protrudes radially inwardly from radially inwardly facing surface 16B).

One or more ports 422 may be provided to allow fluid (e.g., liquid and/or gas) to travel into and out of cavity 418. Each port 422 may define an aperture in body 412 to allow fluid to travel into and out of cavity 418.

In some embodiments, apparatus 410 may comprise a secondary body 430. Secondary body 430 may be substantially annular in shape as best seen in FIG. 7B. Secondary body 430 may have a radially inwardly facing inner surface 430A (e.g., inner surface 430A faces in radial inward direction 7A) and a radially outwardly facing outer surface 430B (e.g., outer surface 430B faces in radial outward direction 7B). Radially inwardly facing inner surface 430A may define a space 432.

In some embodiments, body 412 is located at least partially within space 432. In some embodiments, secondary body 430 is arranged generally concentrically with body 412, as shown in FIG. 7B. A fluid-receiving space 434 may be defined between inner surface 430A and outer surface 412A.

Radially inward facing inner surface 430A may define an inwardly protruding spine (not depicted) substantially similar to spine 20 of apparatus 10 (e.g., substantially similar in shape to spine 20 of apparatus 10) or spine 220 of apparatus 210 (e.g., substantially similar in shape to spine 220 of apparatus 210). In some embodiments, the spine protruding from radially inward facing inner surface 430A is aligned in axial direction 7C with spine 420.

In some embodiments, to fix secondary body 430 relative to body 412, one or more connectors 436 attach secondary body 430 to body 412. In some embodiments, body 412, secondary body 430 and connectors 436 are integrally formed, but this is not mandatory. In some embodiments, connectors 436 are spaced apart from one another (e.g., as shown in FIG. 7B) to allow fluid to flow between connectors 436 to thereby minimize an impact of connectors 436 on the bulk fluid when apparatus 410 is employed.

In some embodiments, an axial direction 7C height of connectors 436 is less than an axial direction 7C height of body 412 and/or secondary body 430 to reduce interference of connectors 436 with the fluid and/or fluid interface being studied. In some embodiments, connectors 436 are located below an axial direction midpoint of body 412 and/or secondary body 430 (e.g., below spine 420) to reduce interference of connectors 436 with the fluid and/or fluid interface being studied. In some embodiments, connectors 436 are located below body 412 and/or secondary body 430 (e.g., below spine 420), as shown in Figured 7A, to reduce interference of connectors 436 with the fluid and/or fluid interface being studied.

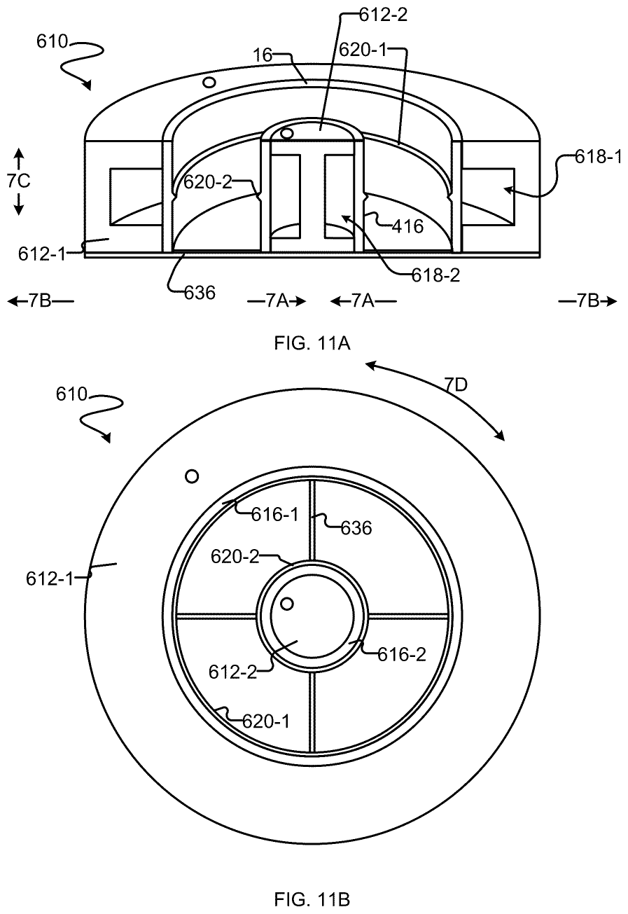

In some embodiments, secondary body 430 may be replaced by one of apparatus 10, apparatus 110, apparatus 210 and apparatus 310. For example, FIGS. 11A and 11B depict an interfacial dilational strain apparatus 610 (referred to herein simply as apparatus 610) according to an example embodiment of the invention. Apparatus 610 may be substantially similar to apparatus 410, except in that secondary body 430 is replaced by apparatus 10.

Apparatus 610 comprises an annular body 612-1 substantially similar to body 12 and a cylindrical body 612-2 substantially similar to body 412. Annular body 612-1 may be attached to cylindrical body 612-2 by one or more connectors 636 Apparatus 610 comprises a first deformable wall 616-1 substantially similar to deformable wall 16 and a second deformable wall 616-2 substantially similar to deformable wall 416. First deformable wall 616-1 may be attached to annular body 612-1 to define a first cavity 618-1. Second deformable wall 616-2 may be attached to cylindrical body 612-2 to define a second cavity 618-2.

Body 630 may be aligned in axial direction 7C with body 612 such that a first spine 620-1 (substantially similar to spine 20) of first deformable wall 616-1 is aligned a second spine 620-2 (substantially similar to spine 420) of second deformable wall 616-2 in axial direction 7C.

In this way, strain can be applied to a fluid interface by deformation of one or both of first deformable wall 616-1 and second deformable wall 616-2. In some embodiments, a volume and/or pressure of fluid within cavities 18 and 418 may be increased simultaneously to “squeeze” a fluid interface between deformable wall 16 and deformable wall 416. Or decreased simultaneously to allow the fluid interface to expand between deformable wall 16 and deformable wall 416.

Another aspect of the invention provides an interfacial dilational rheometer. The interfacial dilational rheometer may comprise an interfacial dilational strain apparatus as described herein located at least partially within an open container. A stress sensor may be provided to determine interfacial tension of a fluid interface within the open container.

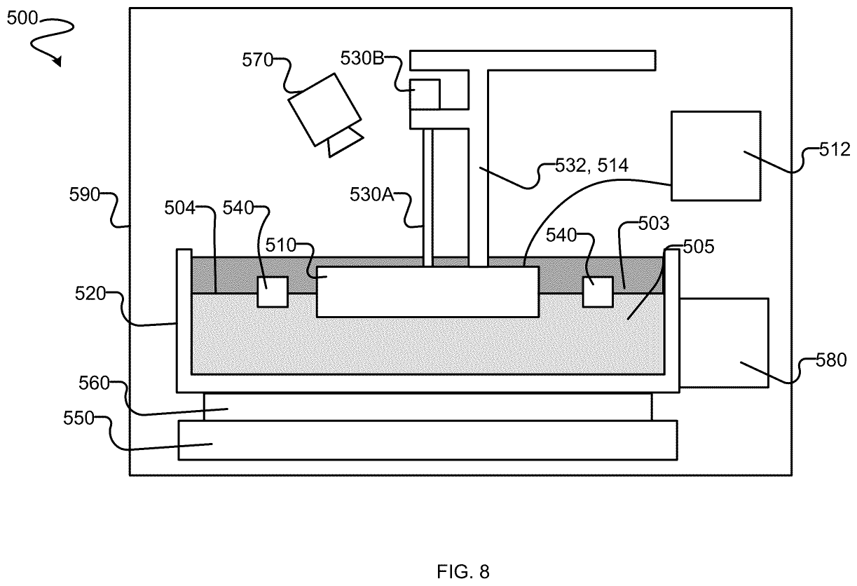

FIG. 8 depicts an interfacial dilational rheometer 500 (referred to herein as rheometer 500) according to an exemplary embodiment of the invention. Rheometer 500 may be employed to measure or quantify stress and/or strain of an interface 504 between fluid 503 and fluid 505. Fluid interface 504 may be, for example, a liquid-gas interface (e.g., where fluid 505 comprises a liquid and fluid 503 comprises a gas) or a liquid-liquid interface (e.g., where both fluid 503 and fluid 505 comprise liquids). Fluid interface 504 may also comprise another material that is insoluble in either fluid phase, such as proteins, solid particles, etc.

Rheometer 500 comprises an interfacial dilational strain apparatus 510 (referred to herein as apparatus 510). Apparatus 510 may comprise any suitable interfacial dilational strain apparatus. Apparatus 510 may comprise an interfacial dilational strain apparatus as described herein (e.g., apparatus 10, 110, 210, 310 or 410). For convenience, rheometer 500 is described herein with reference to apparatus 10 but it should be understood that rheometer 500 could employ another suitable interfacial dilational strain apparatus.

Rheometer 500 comprises a pressure controller 512. Pressure controller 512 may be substantially similar to pressure controller 60. Pressure controller 512 may be part of apparatus 510 (e.g., pressure controller 512 may comprise pressure controller 60) or may be provided separately from apparatus 510 where apparatus 510 does not comprise a pressure controller.

Rheometer 500 comprises a stand 514. Stand 514 may support apparatus 510. Stand 514 may be manually or automatically (e.g., electrically, pneumatically or hydraulically) actuated to raise and/or lower apparatus 510 to facilitate aligning apparatus 510 with interface 504. Stand 514 may be attached to open container 520 (described further herein) but this is not mandatory.

Rheometer 500 comprises an open container 520. Open container 520 may be any suitable open container for holding fluids 503 and/or 505. For example, open container 520 may comprise a Langmuir trough, a radial trough, a quadrotrough, a Petri dish, a custom cell that fastens to apparatus 510 or is integrated in a single-body design with apparatus 510, etc.

Rheometer 500 comprises a stress sensor 530 to measure equilibrium surface or interfacial tension of fluid interface 504. Stress sensor 530 may comprise any suitable stress sensor to measure equilibrium surface or interfacial tension of fluid interface 504. Stress sensor 530 may comprise any suitable sensor to measure a stress applied to fluid interface 504. In some embodiments, stress sensor 530 comprises a force sensor. In some embodiments, stress sensor 530 comprises a probe 530A and a balance 530B for determining a force applied to probe 530A. Balance 530B may comprise any suitable balance such as, for example, a microbalance (e.g., a high-resolution optoelectronic microbalance).

In some embodiments, probe 530A comprises a Wilhelmy rod. Due to the round (e.g., circular) shape of opening 24, employing a Wilhelmy rod as probe 530A may simplify measurement of equilibrium surface or interfacial tension of fluid interface 504. However, a Wilhelmy plate could also be employed as probe 530A. Where apparatus 510 comprises apparatus 410, a ring-shaped probe 530A (e.g., the same or similar to a double wall ring probe) may be employed. Probe 530A may comprise reusable materials like platinum, metal oxides, etc., Probe 530A may comprise disposable materials like paper, nitrocellulose, etc.

Probe 530A may be supported by a stand 532. In some embodiments, stand 532 comprises stand 514 or is a component of stand 514 but this is not mandatory. Stand 532 may be fixed to apparatus 510 to achieve a desired orientation of probe 530A relative to apparatus 510. Stand 532 may additionally or alternatively be fixed to open container 520 to achieve a desired orientation of probe 530A relative to open container 520 and fluid interface 504. Stand 532 may allow for raising and lowering of probe 530A. In some embodiments, stand 532 is manually adjustable to raise and/or lower probe 530A. In some embodiments, stand 532 is hydraulically actuatable, pneumatically actuatable or electrically actuatable to raise and/or lower probe 530A.

In some embodiments, rheometer 500 comprises one or more optional movable barriers 540. Moveable barriers 540 may be employed to apply a desired baseline strain to interface 504 (or otherwise condition interface 504) before apparatus 510 is employed to apply strain to interface 504. Moveable barriers 540 may be similar to the moveable barriers employed in a Langmuir trough, quadrotrough, radial trough, etc.

In some embodiments, open container 520 is vibrationally isolated from an outside environment to prevent or mitigate undesirable disturbance of fluid 503 and/or fluid 505. For example, in some embodiments, rheometer 500 comprises an anti-vibration platform 550 to support open container 520 to prevent or mitigate undesirable disturbance of fluid 505.

In some embodiments, fluid 505 is heated or cooled to achieve a desired temperature of fluid 503 and/or fluid 505. In some embodiments, rheometer 500 comprises a heat system 560 provided in or near (e.g., against, under or adjacent) to open container 520. Heat system 560 may comprise one or more heating elements, a fluid circulation heater, etc.

In some embodiments, rheometer 500 comprises an optional camera 570. Camera 570 may be employed to assist with measuring displacement of deformable wall 16 to better determine a strain applied to interface 504 by apparatus 510. In some embodiments, camera 570 is replaced by sensor 25 or the like. In some embodiments, a camera is employed once or at regular intervals to determine or confirm a relationship between pressure within cavity 18 and displacement of deformable wall 16 such that camera 570 is not required during regular use of rheometer 500. In some embodiments, camera 570 (or another suitable camera) is employed as part of a complementary measurement technique such as Brewster angle microscopy, fluorescence microscopy, etc.

In some embodiments, rheometer 500 comprises a fluid circulation system 580 for circulating bulk fluid 505 within open container 520. Fluid circulation system 580 may be employable to introduce new fluid 505 and/or remove fluid 505 from open container 520. In this way, fluid circulation system 580 may be operable to change a composition of fluid 505 within open container 520. This may assist with obtaining desired properties of a range of fluid compositions without repeatedly removing all fluid 505 and introducing new fluid 505.

In some embodiments, rheometer 500 comprises an enclosure 590 to further isolate fluid 503 and/or 505 from the outside environment. One or more components of rheometer 500 (e.g., apparatus 510, open container 520, stress sensor 530, moveable barriers 540, anti-vibration platform 550, heat system 560, camera 570 and/or fluid circulation system 580) may be located within enclosure 590. The atmosphere within enclosure 590 may be maintained at a desirable temperature, pressure, humidity, etc. by a suitable system including one or more temperature sensors, pressure sensors, humidity sensors and one or more systems for adjusting the temperature, pressure and/or humidity within enclosure 590 (e.g., such as heating system 560).

In practice, rheometer 500 may be operated as follows. Fluid 503, fluid 505 and/or another material that is insoluble in either fluid phase, such as proteins, solid particles, etc. may be dispensed into open container 520 to form interface 504. Where dispensing fluid 503 and/or 505 into open container 520 includes opening enclosure 590, enclosure 590 may then be closed. In some embodiments, fluid 505 is dispensed into open container 520 until interface 504 is aligned with apparatus 510 (e.g., aligned with spine 20 of apparatus 510). Alternatively, stand 514 may be actuated to align apparatus 510 (e.g., spine 20 of apparatus 510) with interface 504 after a desired amount of fluid 505 is dispensed into open container 520. Likewise, a position of probe 530A of stress sensor 530 may be adjusted by actuation of stand 532. Where a temperature of fluid 503 and/or fluid 505 is not as desired, fluid 503 and/or fluid 505 may then be heated by heating system 560. Once a desired temperature, humidity and pressure is achieved within enclosure 590, moveable barriers 540 may then optionally be employed to achieve a desired baseline strain or pre-conditioning of interface 504. Apparatus 510 may then be employed (e.g., by causing pressure controller 512 to increase and/or decrease pressure within cavity 18) to apply strain to interface 504 within apparatus 510 (e.g., within opening 24). The stress applied to interface 504 may be measured by stress sensor 530 or another probe to achieve a similar measurement of interfacial stress.

An inevitable effect of dilating interface 504 is that there may be some flow of bulk fluid 505 in the direction normal to interface 504 because of the incompressibility of liquids (i.e., conservation of mass). In the present design, the bulk flow can result in a temporary change to the depth of fluid 505 within opening 24. This change in liquid depth at the location of the probe 530A may produce an additional buoyant force on probe 530A. However, based on conservative estimates, the change of level of interface 504 due to oscillation of deformable wall 16 is negligible in most cases due to the relatively low oscillation frequency and large bulk volume of fluid 505. In the case when the change of liquid level needs to be considered, it could impact the measured interfacial tension in the form of buoyant force (inertia and drag may be negligible in many cases) and limit the sensitivity of rheometer 500. In other situations where the oscillation frequencies and/or amplitudes are high, gravity or capillary waves might need to therefore be taken into consideration.

In practice, stress at interface 504 can include multiple components, and probe 530A (e.g., the Wilhelmy rod) measures the summation of all of them. When characterizing interfacial rheology, it may therefore be desirable to understand the physical meaning of the measured stress and, if possible, separately quantify the different contributions. For example, a soluble surfactant at very low oscillation frequency may maintain a constant surface tension and the dilational moduli may therefore be zero. However, at very high frequency, the surfactant may behave like an insoluble surfactant and the dilational storage modulus may therefore correspond to the maximum Gibbs elasticity, while the dilational viscosity may be zero (for small-molecule surfactants). On the other hand, at intermediate frequencies, because of adsorption and desorption, both the storage (E′) and loss (E″) moduli of the system may be non-zero. For the simple case of diffusion-driven adsorption of small-molecule surfactants, Lucassen and Van den Tempel (LvdT) developed the following equation for predicting this frequency dependence:

$${E}^{′} = {E}_{Gibbs , sol .} \frac{1 + ζ}{1 + 2 ζ + 2 {ζ}^{2}} , {E}^{″} = {E}_{Gibbs , sol .} \frac{ζ}{1 + 2 ζ + 2 {ζ}^{2}} , \qquad ( Equation 5 )$$

$$ζ = \frac{dc}{d Γ} \sqrt{\frac{D}{4 π ω}} .$$

where c and Γ are bulk and surface concentration, D is diffusion coefficient, and ω is the frequency of oscillation. However, while the LvdT model may be useful for some small-molecule surfactants, there are a number of other factors in some systems that will violate the underlying assumptions. In some cases, the LvdT model can be modified to account for these deviations. For example, for a mixture of a soluble and an insoluble surfactant, it can be assumed that the contribution of each to the overall stress is additive (linear). Making this assumption results in the following equation:

$${σ}_{Total} = {σ}_{ST} + {σ}_{Insoluble} + {σ}_{Soluble} = ϵ {E}_{Gibbs , insol .} + ϵ {E}^{′} ( ω ) + \dot{ϵ} {E}^{″} ( ω ) / ω \qquad ( Equation 6 )$$

### Experimental Results

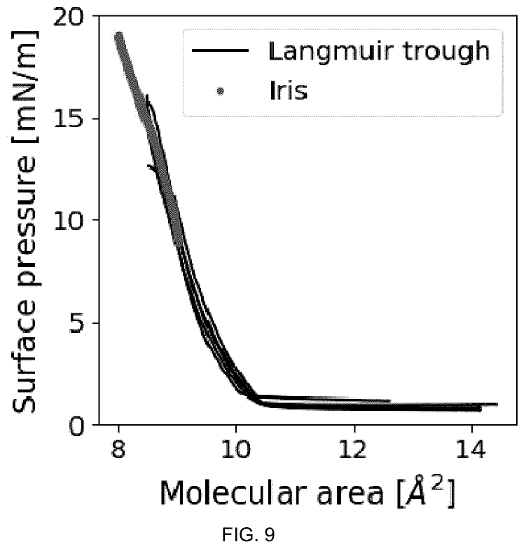

A compression isotherm of stearic acid was obtained with an embodiment of the rheometer 500. The results obtained were compared against the results of a Langmuir trough. The stearic acid powder was first dissolved in hexane at a concentration of 0.5 mg/ml. Then, 250 μl of the solution was deposited onto the interface and let set for 15 min for the solvent to evaporate. The compression isotherm was first measured by the Langmuir trough in the range of approximately 10 to 15 Å² per molecule, with the compression rate being 1 mm/s. The range of molecular area was selected to allow observation of the region where the surface tension is approximately constant and the region where surface tension changes rapidly with changing area. After the compression isotherm was measured, the surface pressure was adjusted to be 1 mN/m, and apparatus 10 was lowered onto the interface. A 10% strain was applied at a rate of 5×10-4 s⁻¹. The relationship between surface pressure and molecular area obtained by the two methods is shown in FIG. 9. As can be seen from FIG. 9, the results of rheometer 500 are consistent with the results from the Langmuir trough.

In another example, rheometer 500 was employed to carry out dynamic measurements by using a soluble surfactant, Sodium dodecylbenzenesulfonate (SDBS). A frequency sweep and an amplitude sweep were carried out on an SDBS solution with a concentration of approximately 0.285 mM. For the frequency sweep, the oscillation frequencies ranged from 10⁻⁴ to 0.2 Hz with an amplitude of 2.5% strain. For the amplitude sweep, the frequency and amplitudes were 0.01 Hz and 0.1%, 0.2%, 0.5%, 1%, 2%, 4%, 5% strain. For high frequency oscillations (e.g., greater than approximately 10⁻³ Hz), 5 to 10 oscillations of sinusoidal strain were applied, and both strain and stress were fit to sine functions to obtain a complex modulus and phase angle. For low frequencies (e.g., less than approximately 10⁻³ Hz), since the period was too long to execute a full oscillation, a steady, linear ramping strain was generated to obtain the storage and loss moduli once the stress also became linear with time.

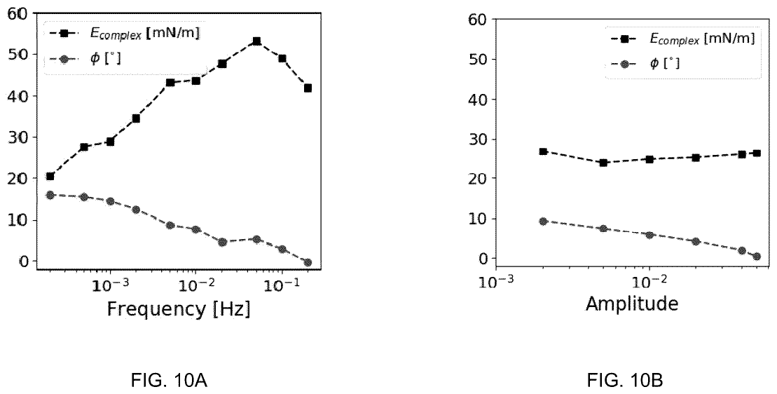

FIG. 10A and FIG. 10B show the modulus and phase angle for the two measurements. The magnitude of the dilational complex moduli is similar to what is measured by the pendant droplet method. The data suggests that the overall phase angle decreases with frequency, while the overall complex modulus increases. Both observations agree with the content of Lucassen and van den Tempel theory. In the amplitude sweep, the complex modulus does not change for amplitudes larger than 0.2%. This is anticipated since it suggests that the range of strain is within the linear regime. The phase angle of the amplitude measurements gradually decreases with amplitude. This may be due to the increasing strain rate applied. Although the frequency is kept the same, the amplitude of oscillation increases, resulting in an increase in the strain rate. Therefore, the interface exhibits a more elastic behavior, similar to that under higher frequencies.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about” or “approximately”. In this context, “about” or “approximately” provides literal support for the exact numerical value that it precedes, the exact numerical value ±10%, as well as all other numerical values that are near to or approximately equal to that numerical value. Unless otherwise indicated a particular numerical value is included in “about” or “approximately” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.0 to 11.0;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. An interfacial dilational strain apparatus, the apparatus comprising:
a body having a first surface facing in a first radial direction wherein the first surface defines a channel having an opening facing in the first radial direction;
a deformable wall sealingly attached to the body to cover the opening of the channel wherein the deformable wall and the channel define a cavity; and
one or more ports fluidly connected to the cavity;
wherein the deformable wall is deformable in the first radial direction by increasing a fluid pressure or volume within the cavity and the deformable wall is deformable in a second radial direction opposite the first radial direction by decreasing the fluid pressure or volume within the cavity.

2. An apparatus according to claim 1 wherein a first surface of the deformable wall defines a spine, the spine protruding in the first radial direction from the first surface of the deformable wall.

3. An apparatus according to claim 2 wherein the spine extends around an entirety of the first surface of the deformable wall.

4. An apparatus according to claim 2 wherein the spine extends around at least a portion of the first surface of the deformable wall.

5. An apparatus according to claim 2 wherein a tip of the spine is aligned with an axial direction midpoint of the channel.

6. An apparatus according to claim 2 wherein at least a portion of the spine is substantially triangular in cross-section.

7. An apparatus according to claim 2 wherein an axial direction dimension of the spine tapers in the first radial direction.

8. An apparatus according to claim 1 wherein the channel is substantially rectangular in cross-section.

9. An apparatus according to claim 1 wherein the channel is substantially round in cross-section.

10. An apparatus according to claim 1 wherein the channel is substantially semi-circular in cross-section.

11. An apparatus according to claim 1 comprising a pressure controller fluidly connected to the one or more ports and operable to control the fluid pressure or volume within the cavity by forcing fluid into or out of the cavity.

12. An apparatus according to claim 1 wherein the first radial direction is a radially-inward direction and the second radial direction is a radially-outward direction.

13. An apparatus according to claim 12 wherein the body is an annular body.

14. An apparatus according to claim 1 wherein the first radial direction is a radially-outward direction and the second radial direction is a radially-inward direction.

15. An apparatus according to claim 14 comprising an annular secondary body wherein the annular secondary body defines a space and the body is located at least partially within the space.

16. An apparatus according to claim 15 wherein the body and the secondary body are arranged concentrically.

17. An apparatus according to claim 15 comprising one or more connectors attaching the secondary body to the body.

18. An apparatus according to claim 17 wherein the one or more connectors are located below the body and below the secondary body.

19. An interfacial dilation rheometer comprising:
an open container;
the interfacial dilational strain apparatus of claim 1 wherein the interfacial dilational strain apparatus is located at least partially within the open container; and
a stress sensor configured to determine a stress at an interface of a fluid receivable within the open container.

20. An interfacial dilational strain apparatus, the apparatus comprising:
an annular body having a first surface facing in a radial inward direction wherein the first surface defines a channel having an opening facing in the radial inward direction;
a deformable wall sealingly attached to the body to cover the opening of the channel wherein the deformable wall and the channel define a cavity; and
one or more ports fluidly connected to the cavity;
wherein the deformable wall is deformable in the radial inward direction by increasing a fluid pressure or volume within the cavity and the deformable wall is deformable in a radial outward direction by decreasing the fluid pressure or volume within the cavity.
